(19) United States
(12) Patent Application Publication
(10) Pub. No.: US 2026/0238104 A1
(43) Pub. Date: Aug. 13, 2026

(54) VIBRATION EXCITER AND ELECTRONIC DEVICE

(71) Applicant: MERRY ELECTRONICS (SUZHOU) CO., LTD., Suzhou City (CN)

(72) Inventors: Jiawei ZHU, Suzhou City (CN); Mingya LUO, Suzhou City (CN)

(73) Assignee: MERRY ELECTRONICS (SUZHOU) CO., LTD., Suzhou City (CN)

(21) Appl. No.: 19/259,443

(22) Filed: Jul. 3, 2025

(30) Foreign Application Priority Data
Feb. 13, 2025 (CN) 202520228710.3
Feb. 13, 2025 (CN) 202520228743.8

(51) Int. Cl. H02K 33/00; H02K 5/04

(52) U.S. Cl. CPC H02K 33/00; H02K 5/04

(57) ABSTRACT

Provided are a vibration exciter and an electronic device. The vibration exciter includes a housing, a magnetic circuit system disposed in the housing and connected to the housing, a magnetic conductive assembly, and a coil. The housing includes a first housing, a second housing, and a first cantilever structure connected therebetween. The first cantilever structure is elastically deformable. The magnetic conductive assembly is disposed in the housing. The magnetic conductive assembly includes a first magnetic conductive sheet and a second cantilever structure that are integrally formed. The first magnetic conductive sheet is connected to the magnetic circuit system. The second cantilever structure is elastically deformable. The first magnetic conductive sheet is connected to the housing by the second cantilever structure. The coil is disposed in the housing and connected to the second housing. The magnetic circuit system is configured to vibrate relative to the coil.

### CROSS-REFERENCE TO RELATED APPLICATION(S)

This application claims priority of Chinese Patent Applications filed with China National Intellectual Property Administration (CNIPA) on Feb. 13, 2025, with application No. 202520228743.8 and 202520228710.3, the disclosures of which are incorporated herein by reference in their entireties.

### TECHNICAL FIELD

This disclosure relates to the field of exciters, particularly a vibration exciter and an electronic device.

### BACKGROUND

Electronic devices such as mobile phones, tablets, and handheld multimedia entertainment devices typically use exciters to provide system feedback, such as vibration feedback of mobile phones and game consoles.

In the related art, to avoid openings for producing sound, an electronic device uses the screen or the housing of the electronic device to produce sound through vibration, with an exciter being the vibration source of the screen or the housing. The exciter includes a housing and a magnetic circuit system, a magnetic conductive sheet, and a coil that are disposed in the housing. When energized, the coil generates a magnetic field. The magnetic circuit system converts electrical energy into mechanical energy through electromagnetic induction. The magnetic circuit system and the magnetic conductive sheet are connected to the housing. When an electronic device equipped with an exciter drops, the impact force is directly transmitted by the housing to the magnetic circuit system and the magnetic conductive sheet, causing damage to the magnetic circuit system and the magnetic conductive sheet and leading to weak impact resistance of the exciter.

Therefore, there is an urgent need for a vibration exciter and an electronic device with enhanced drop resistance.

### SUMMARY

This disclosure provides a vibration exciter and an electronic device.

As conceived above, the solution used by this disclosure is as follows:

The vibration exciter includes a housing, a magnetic circuit system, a magnetic conductive assembly, and a coil.

The housing includes a first housing, a second housing, and a first cantilever structure connected between the first housing and the second housing. The first cantilever structure is elastically deformable.

The magnetic circuit system is disposed in the housing and connected to the first housing.

The magnetic conductive assembly is disposed in the housing. The magnetic conductive assembly includes a first magnetic conductive sheet and a second cantilever structure that are integrally formed. The first magnetic conductive sheet is connected to the magnetic circuit system. The second cantilever structure is elastically deformable. The first magnetic conductive sheet is connected to the housing by the second cantilever structure.

The coil is disposed in the housing and connected to the second housing. The magnetic circuit system is configured to vibrate relative to the coil.

In an embodiment, the second cantilever structure includes a first annular portion and multiple first connectors. The first connectors are spaced apart along the circumferential direction of the first magnetic conductive sheet. For each first connector, one end of the first connector is connected to the first magnetic conductive sheet, the other end of the first connector is connected to the first annular portion, and the first connector is elastically deformable. The first annular portion is connected to the housing.

In an embodiment, the second cantilever structure includes multiple first connectors. The first connectors are spaced apart along the circumferential direction of the first magnetic conductive sheet. For each first connector, one end of the first connector is connected to the first magnetic conductive sheet, the other end of the first connector is connected to the housing, and the first connector is elastically deformable.

In an embodiment, each first connector includes at least two first connecting portions connected end to end. Two connected first connecting portions are arranged at an obtuse angle.

In an embodiment, the first housing and the first cantilever structure are an integral structure, and the second cantilever structure is connected to at least one of the second housing, the first cantilever structure, or the second housing.

In an embodiment, the first cantilever structure includes a second annular portion and multiple second connectors. The second connectors are spaced apart along the circumferential direction of the first housing. For each second connector, one end of the second connector is connected to the first housing, the other end of the second connector is connected to the second annular portion, and the second connector is elastically deformable. The second annular portion is connected to the second housing.

Alternatively, the first cantilever structure includes multiple second connectors. The second connectors are spaced apart along the circumferential direction of the first housing. For each second connector, one end of the second connector is connected to the first housing, the other end of the second connector is connected to the second housing, and the second connector is elastically deformable.

In an embodiment, the magnetic conductive assembly also includes a second magnetic conductive sheet. The second magnetic conductive sheet and the first magnetic conductive sheet are disposed in the same layer and spaced apart. The coil passes through the space between the first magnetic conductive sheet and the second magnetic conductive sheet.

The magnetic circuit system includes a primary magnet and a secondary magnet disposed in the same layer as the primary magnet. The primary magnet and the secondary magnet are both connected to the first housing. A magnetic gap is formed between the primary magnet and the secondary magnet. At least part of the coil extends into the magnetic gap.

The first magnetic conductive sheet is connected to the secondary magnet. The second magnetic conductive sheet is connected to the primary magnet.

In an embodiment, multiple secondary magnets are spaced apart along the circumferential direction of the primary magnet, and the first magnetic conductive sheet is annular. The secondary magnets are all connected to the first magnetic conductive sheet.

In an embodiment, the vibration exciter also includes a buffer layer disposed between the magnetic conductive assembly and the housing.

An electronic device includes the vibration exciter and a device body. The housing of the vibration exciter is connected to the device body.

### BRIEF DESCRIPTION OF DRAWINGS

To illustrate solutions of embodiments of this disclosure more clearly, drawings used in the description of the embodiments of this disclosure are briefly described hereinafter. Apparently, the drawings described hereinafter illustrate some of the embodiments of this disclosure. Those of ordinary skill in the art may also obtain other drawings based on the content of the embodiments of this disclosure and the drawings on the premise that no creative work is done.

FIG. 1 is a first view illustrating the structure of a vibration exciter according to an embodiment of this disclosure.

FIG. 2 is a second view illustrating the structure of a vibration exciter according to an embodiment of this disclosure.

FIG. 3 is an exploded view of a vibration exciter according to an embodiment of this disclosure.

FIG. 4 is a first section view of a vibration exciter according to an embodiment of this disclosure.

FIG. 5 is a view of a first magnetic conductive sheet and a first cantilever structure according to an embodiment of this disclosure.

FIG. 6 is a view of a first housing and a second cantilever structure according to an embodiment of this disclosure.

FIG. 7 is a second section view of a vibration exciter according to an embodiment of this disclosure.

### DETAILED DESCRIPTION

To make the technical problems solved, the technical solutions used, and the technical effects achieved in this disclosure more apparent, the technical solutions of this disclosure are further described below in conjunction with the drawings and embodiments. It is to be understood that the embodiments described herein are intended to illustrate and not to limit this disclosure. Additionally, it is to be noted that for ease of description, part, not all, related to this disclosure is illustrated in the drawings.

It is to be noted that similar reference numerals and letters represent similar items in the drawings. Therefore, once an item is defined in one drawing, the item no longer needs to be defined and interpreted in the subsequent drawings.

In the description of this disclosure, unless otherwise expressly specified and limited, the term “connected to each other”, “connected”, or “secured” is to be construed in a broad sense, for example, as securely connected, detachably connected or integrated; mechanically connected or electrically connected; directly connected to each other or indirectly connected to each other via an intermediary; or internally connected or an interactional relationship between two elements. For those of ordinary skill in the art, specific meanings of the preceding terms in this disclosure may be understood based on specific situations.

In this disclosure, unless otherwise expressly specified and limited, when a first feature is described as being “on” or “below” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature. In the description of this embodiment, “multiple” means two or more unless otherwise specified.

In the description of this application, it is to be understood that the orientation or position relationships indicated by terms such as “center”, “longitudinal”, “lateral”, “length”, “width”, “thickness”, “above”, “below”, “front”, “back”,” “left”, “right”, “vertical”, “horizontal”, “top”, “bottom”, “inside”, “outside”, “clockwise”, “counterclockwise”, “axial”, “radial”, and “circumferential” are based on the orientation or position relationships shown in the drawings. These terms are intended for brief and simple description and do not indicate or imply that the device or element referred to has a particular orientation and is constructed and operated in a specific orientation. Thus, these terms cannot be construed as limiting this disclosure. In addition, the terms “first” and “second” are used for distinguishing between descriptions and have no special meaning.

It is to be noted that when a component is described as being “secured to” or “disposed on” another component, this component may be directly on the other component, or an intervening component may be on the other component.

The technical solutions of this disclosure are further described hereinafter in conjunction with the drawings and the embodiments.

This embodiment provides a vibration exciter, which has strong drop resistance and impact resistance, and high reliability.

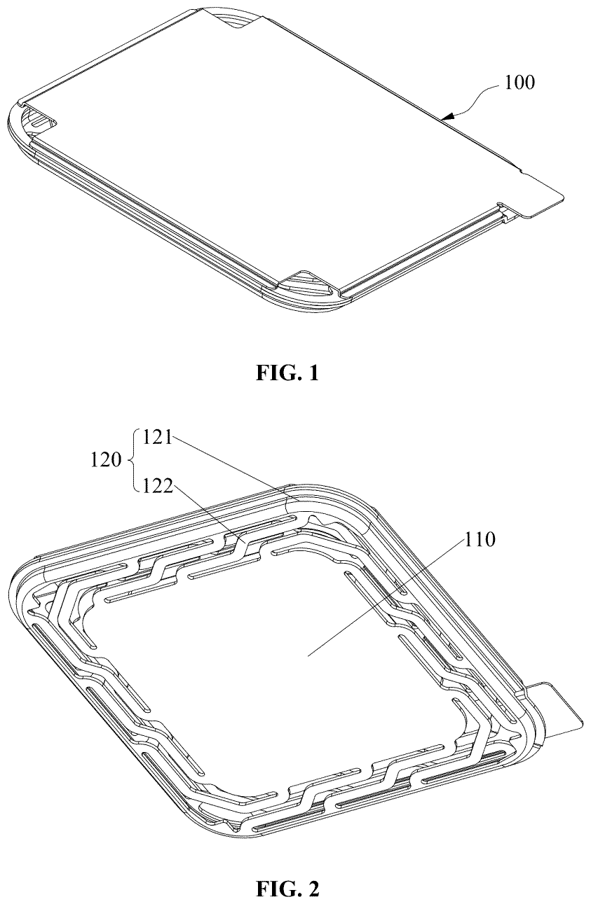

Illustratively, as shown in FIG. 1 to FIG. 7, the vibration exciter includes a housing 100 and a magnetic circuit system 200, a magnetic conductive assembly 300, and a coil 400 that are all disposed in the housing 100. The housing 100 has an internal cavity (not shown). The magnetic circuit system 200, the magnetic conductive assembly 300, and the coil 400 are all disposed in the internal cavity. The housing 100 of this embodiment may be made of a metal material or a non-metal material. This is not limited in this embodiment. The shape of the housing 100 of this embodiment may be determined according to actual applications. For example, the housing 100 may be square, cylindrical, or frustum-shaped. The drawings of this embodiment provide a square housing 100. For ease of understanding, in this embodiment, the thickness direction of the housing 100 is referred to as a first direction X, and the length direction and the width direction of the housing 100 are perpendicular to the first direction X.

Illustratively, the housing 100 includes a first housing 110, a first cantilever structure 120, and a second housing 130. The first cantilever structure 120 is connected between the first housing 110 and the second housing 130. In this embodiment, the first cantilever structure 120 is elastically deformable. The first housing 110 is connected to the second housing 130 by the first cantilever structure 120. In this manner, when one of the first housing 110 or the second housing 130 is subjected to an impact force, the impact force can be transmitted to the first cantilever structure 120, and the first cantilever structure 120 performs force buffering and suction, thereby reducing the impact force transmitted from the first housing 110 and the second housing 130 to the magnetic circuit system 200 and the first magnetic conductive sheet 310 and further reducing the impact force received by the magnetic circuit system 200 and the first magnetic conductive sheet 310.

In some embodiments, the magnetic circuit system 200 is connected to the first housing 11; in this manner, when the magnetic circuit system 200 vibrates, the first housing 110 can be driven to vibrate so that the electronic device can generate vibration feedback.

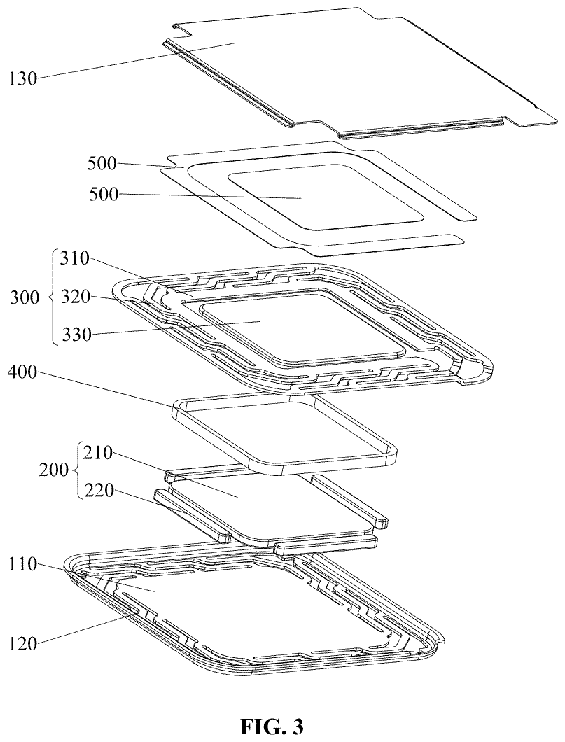

As shown in FIG. 3, the magnetic conductive assembly 300 includes a first magnetic conductive sheet 310 and a second cantilever structure 320 that are integrally formed, that is, the first magnetic conductive sheet 310 and the second cantilever structure 320 are an integral structure. The first magnetic conductive sheet 310 and the second cantilever structure 320 are made of the same material. The first magnetic conductive sheet 310 is connected to the magnetic circuit system 200. The second cantilever structure 320 is elastically deformable. The first magnetic conductive sheet 310 is connected to the housing 100 by the second cantilever structure 320. With the second cantilever structure 320, the first magnetic conductive sheet 310 can be elastically connected to the housing 100. When the vibration exciter collides, the impact force received by the housing 100 is transmitted to the magnetic circuit system 200 and the first magnetic conductive sheet 310 and then buffered and absorbed by the second cantilever structure 320, thereby reducing the impact force received by the magnetic circuit system 200 and the first magnetic conductive sheet 310, reducing the risk of damage to the magnetic circuit system 200 and the first magnetic conductive sheet 310, and making the vibration exciter more resistant to drop tests, tumble tests, and other strength tests. In one or more embodiments, the first magnetic conductive sheet 310 and the second cantilever structure 320 may be made of low carbon steel (steel plate cold rolled commercial (SPCC)), cold rolled steel (steel plate cold rolled grade G (SPCG)), or other magnetic conductive materials.

The coil 400 of this embodiment is connected to the second housing 130. Magnetic circuit system 200 can vibrate relative to the coil 400. For example, the magnetic circuit system 200 can vibrate relative to the coil 400 in the first direction X. It is to be noted that the coil 400 generates an induced magnetic field after being energized. The magnetic circuit system 200 can vibrate relative to the coil 400 under the action of the induced magnetic field. When the magnetic circuit system 200 vibrates, the first housing 110 of the housing 100 can be driven to vibrate. The first housing 110 of the housing 100 is connected to the device body of the electronic device so that the device body can be driven to vibrate, thereby achieving vibration feedback of the electronic device.

In the vibration exciter of this embodiment, the magnetic conductive assembly 300 includes a first magnetic conductive sheet 310 and a second cantilever structure 320 that are integrally formed. The first magnetic conductive sheet 310 and the second cantilever structure 320 that are integrally formed have a higher overall structural strength than a split structure. The first magnetic conductive sheet 310 can be elastically connected to the housing 100 by the second cantilever structure 320. When the impact force received by the housing 100 is transmitted to the first magnetic conductive sheet 310 by the second cantilever structure 320 when the vibration exciter collides, the buffering and energy absorption of the second cantilever structure 320 can reduce the force transmitted to the first magnetic conductive sheet 310, thereby reducing the force transmitted to the magnetic circuit system 200 from the first magnetic conductive sheet 310 and reducing the probability of damage to the first magnetic conductive sheet 310 and the magnetic circuit system 200. Thus, the vibration exciter has strong drop resistance and strong impact resistance, satisfying the requirements of drop tests.

After the impact force received by the housing 100 is directly transmitted to the magnetic circuit system 200, the magnetic circuit system 200 transmits the force to the first magnetic conductive sheet 310. Then the first magnetic conductive sheet 310 transmits the force to the second cantilever structure 320. The second cantilever structure 320 buffers and absorbs the force, thereby reducing the impact force received by the magnetic circuit system 200 and the first magnetic conductive sheet 310 and reducing the risk of damage to the first magnetic conductive sheet 310 and the magnetic circuit system 200.

Moreover, the integral design of the first magnetic conductive sheet 310 and the second cantilever structure 320 can reduce the number of components and simplify the assembly process, thereby reducing the material cost, improving the yield of the vibration exciter, and greatly reducing the price cost of the entire vibration exciter.

In one or more embodiments, the second cantilever structure 320 may have various structures. This embodiment provides the second cantilever structure 320 having the following two structures:

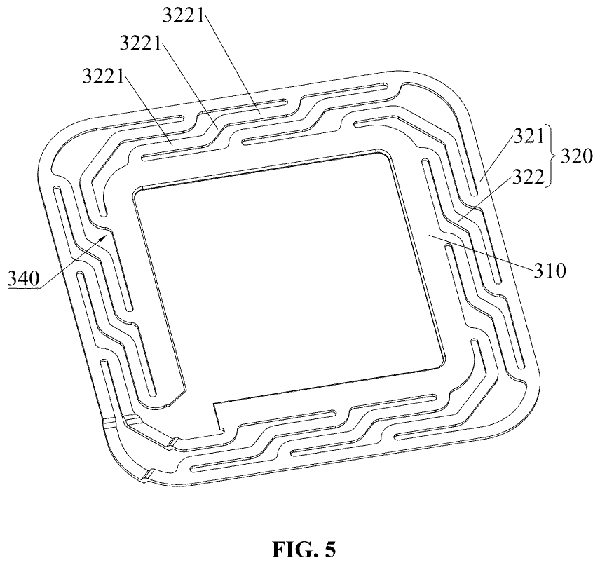

In an embodiment of the second cantilever structure 320, as shown in FIG. 5, the second cantilever structure 320 includes a first annular portion 321 and multiple first connectors 322. The first connectors 322 are spaced apart along the circumferential direction of the first magnetic conductive sheet 310. For each first connector 322, one end of the first connector 322 is connected to the first magnetic conductive sheet 310, the other end of the first connector 322 is connected to the first annular portion 321, and the first connector 322 is elastically deformable. The first annular portion 321 is connected to the housing 100. For example, the first annular portion 321 is connected to the second housing 130 and/or the first cantilever structure 120.

It is to be noted that the first connectors 322 may be elastically deformed in the first direction X or may be elastically deformed in the direction perpendicular to the first direction X to buffer forces from different directions. The first connectors 322 have a high buffering capability. In this embodiment, the first connectors 322 are all disposed in the same layer as the first magnetic conductive sheet 310. The first annular portion 321 is also disposed in the same layer as the first magnetic conductive sheet 310. That is, the top surfaces (or bottom surfaces) of the first connectors 322, the top surface (or bottom surface) of the first magnetic conductive sheet 310, and the top surface (or bottom surface) of the first annular portion 321 are coplanar so that on the basis of ensuring the buffering performance, the space occupied by the magnetic conductive assembly 300 in the first direction X is relatively small, facilitating the lightness and thinness of the vibration exciter.

Illustratively, as shown in FIG. 5, a through hole 340 is formed by being enclosed by two first connectors 322 adjacent in the circumferential direction of the first magnetic conductive sheet 310, the first magnetic conductive sheet 310, and the first annular portion 321. The through hole 340 provides a movement space for the first connectors 322 to ensure the buffering performance and the suction performance of the second cantilever structure 320.

Each first connector 322 may have various structures. This embodiment provides one type of first connector 322. As shown in FIG. 5, the first connector 322 includes at least two first connecting portions 3221 connected end to end. Two connected first connecting portions 3221 are arranged at an obtuse angle. In this manner, with the first connecting portions 3221, the length of each first connector 322 can be longer so that the first connector 322 has a larger deformation amplitude in the first direction X, better improving the buffering performance of the second cantilever structure 320 and improving the impact resistance of the vibration exciter. In addition, two connected first connecting portions 3221 are arranged at an obtuse angle so that the size of the first connector 322 in the direction perpendicular to the first direction X is not excessively large, and both the length and the width of the vibration exciter can be relatively small, thereby facilitating miniaturization of the vibration exciter.

To better increase the number of first connectors 322 between the first magnetic conductive sheet 310 and the first annular portion 321, illustratively, as shown in FIG. 5, the connection position between each first connector 322 and the first magnetic conductive sheet 310 is a first connection position, the connection position between each first connector 322 and the first annular portion 321 is a second connection position, and the first connection position and the second connection position are staggered in the direction perpendicular to the first direction X. That is, the first connection position and the second connection position corresponding to one first connector 322 are not opposite in the length direction or the width direction of the housing 100. In this manner, when it is ensured that the length of each first connector 322 is relatively long, the first connectors 322 can be in concave-convex fit so that the first connectors 322 can be disposed in a small space and arranged regularly.

In another embodiment of the second cantilever structure 320, the second cantilever structure 320 may be provided with no first annular portion 321. The second cantilever structure 320 includes multiple first connectors 322. The first connectors 322 are spaced apart along the circumferential direction of the first magnetic conductive sheet 310. For each first connector 322, one end of the first connector 322 is connected to the first magnetic conductive sheet 310, the other end of the first connector 322 is connected to the housing 100, and the first connector 322 is elastically deformable. In this manner, the buffering performance and the suction performance of the second cantilever structure 320 can be achieved through the elastic deformation of the first connectors 322. It is to be noted that the first connectors 322 may have various structures. For example, the first connector 322 includes at least two second connecting portions 1221 connected end to end. Two connected second connecting portions 1221 are arranged at an obtuse angle so that the first connector can be longer. In this embodiment, the other end of the first connector is connected to the second housing 130 and/or the first cantilever structure 120.

In an embodiment, as shown in FIG. 3, the first housing 110 and the first cantilever structure 120 are an integral structure, that is, the first housing 110 and the first cantilever structure 120 are integrally formed, so that the number of components included in the housing 100 can be relatively small, thereby facilitating assembly of the housing 100. In addition, the integrated first housing 110 and the first cantilever structure 120 can have relatively high integrity.

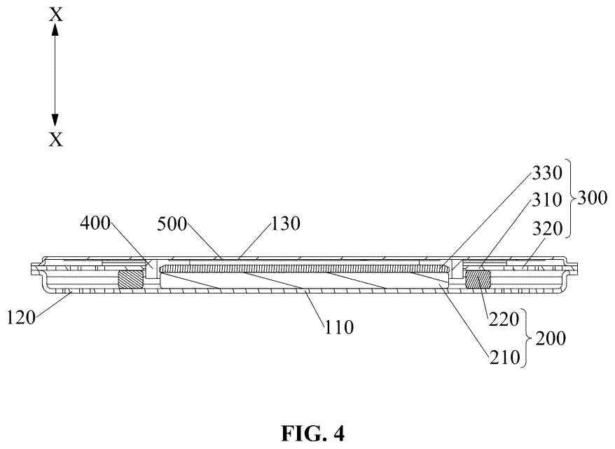

In some embodiments, the second cantilever structure 320 is connected to at least one of the first housing 110, the first cantilever structure 120, or the second housing 130. Illustratively, as shown in FIG. 4, the first annular portion 321 of the second cantilever structure 320 is sandwiched between the second housing 130 and the first cantilever structure 120 to have relatively high connection strength, thereby improving the integrity of the housing 100.

It is to be noted that the second housing 130 may be made of ferromagnetic stainless steel, copper, or another non-magnetic alloy, and the first housing 110 and the first cantilever structure 120 may be made of stainless steel such as SUS304 or SUS430F. The first housing 110 and the first cantilever structure 120 may or may not be magnetic.

Similar to the second cantilever structure 320, the first cantilever structure 120 may be implemented in various manners.

In an embodiment of the first cantilever structure 120, the first cantilever structure 120 includes a second annular portion 121 and multiple second connectors 122. The second connectors 122 are spaced apart along the circumferential direction of the first housing 110. For each second connector 122, one end of the second connector 122 is connected to the first housing 110, the other end of the second connector 122 is connected to the second annular portion 121, and the second connector 122 is elastically deformable. The second annular portion 121 is connected to the second housing 130.

It is to be noted that the second connectors 122 may be elastically deformed in the first direction X or may be elastically deformed in the direction perpendicular to the first direction X to buffer forces from different directions. The second connectors 122 have a high buffering capability.

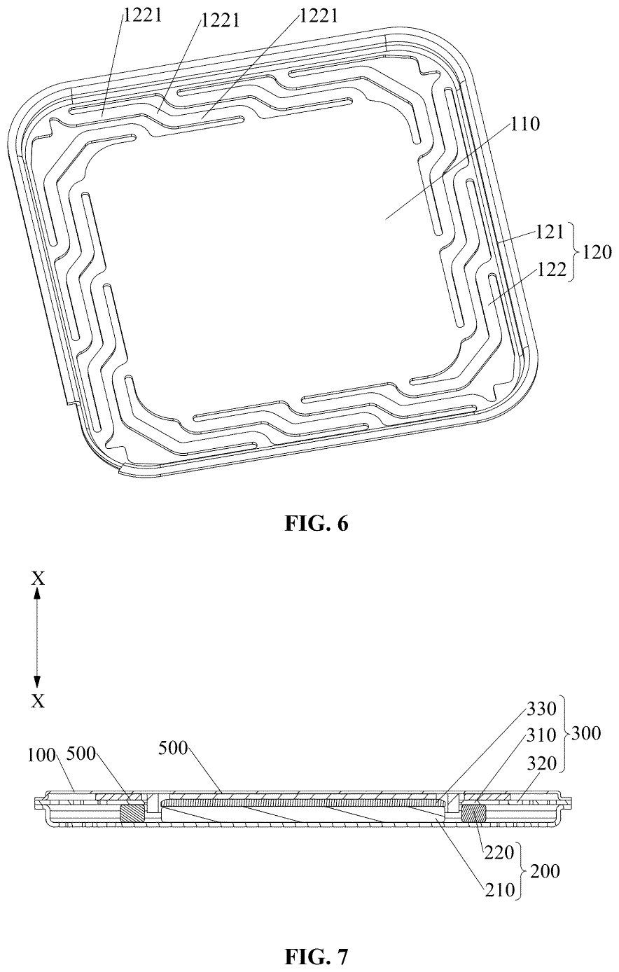

The second connector 122 may have various structures. This embodiment provides one type of second connector 122. As shown in FIG. 6, the second connector 122 includes at least two second connecting portions 1221 connected end to end. Two connected second connecting portions 1221 are arranged at an obtuse angle. In this manner, with the second connecting portions 1221, the length of the second connector 122 can be longer so that the second connector 122 has a larger deformation amplitude in the first direction X, better improving the buffering performance of the first cantilever structure 120 and improving the impact resistance of the housing 100 and the vibration exciter. In addition, two connected second connecting portions 1221 are arranged at an obtuse angle so that the size of the second connector 122 in the direction perpendicular to the first direction X is not excessively large, and both the length and the width of the housing 100 can be relatively small, thereby facilitating miniaturization of the vibration exciter.

To better increase the number of second connectors 122 between the first magnetic conductive sheet 310 and the first annular portion 321, illustratively, as shown in FIG. 6, the connection position between each second connector 122 and the first housing 110 is a third connection position, the connection position between each second connector 122 and the second annular portion 121 is a fourth connection position, and the third connection position and the fourth connection position are staggered in the direction perpendicular to the first direction X. That is, the third connection position and the fourth connection position corresponding to one second connector 122 are not opposite in the length direction or the width direction of the housing 100. In this manner, when it is ensured that the length of each second connector 122 is relatively long, the second connectors 122 can be in concave-convex fit so that the second connectors 122 can be disposed in a small space and arranged regularly.

In another embodiment of the first cantilever structure 120, the first cantilever structure 120 may not include the second annular portion 121, but include multiple second connectors 122. The second connectors 122 are spaced apart along the circumferential direction of the first housing 110. For each second connector 122, one end of the second connector 122 is connected to the first housing 110, the other end of the second connector 122 is connected to the second housing 130, and the second connector 122 is elastically deformable.

In some embodiments, the first cantilever structure 120 and the second cantilever structure 320 are opposite in the first direction X so that the vibration exciter is a double-layer cantilever structure. In this manner, the rotational rigidity of the vibration exciter can be increased, thereby suppressing swinging of the vibration exciter, reducing the magnetic gap of the magnetic circuit system 200, and improving the reliability and vibration performance of the vibration exciter.

In this embodiment, when the housing 100 includes a first housing 110 and a second housing 130, as shown in FIG. 4, one surface of the magnetic circuit system 200 in the first direction X is connected to the first housing 110, the other surface of the magnetic circuit system 200 in the first direction X is connected to the first magnetic conductive sheet 310, and the first magnetic conductive sheet 310 is spaced apart from the second housing 130.

To improve the magnetic induction intensity of the vibration exciter, in an embodiment, as shown in FIG. 3, the magnetic conductive assembly 300 also includes a second magnetic conductive sheet 330. The second magnetic conductive sheet 330 and the first magnetic conductive sheet 310 are disposed in the same layer and spaced apart from each other. For example, the first magnetic conductive sheet 310 may be annular. The second magnetic conductive sheet 330 is disposed at the ring center of the first magnetic conductive sheet 310 and spaced apart from the first magnetic conductive sheet 310. As shown in FIG. 4, the coil 400 passes through the gap between the first magnetic conductive sheet 310 and the second magnetic conductive sheet 330 to facilitate interaction with the magnetic circuit system 200.

In this embodiment, as shown in FIG. 3, the magnetic circuit system 200 in cooperation with the magnetic conductive assembly 300 includes a primary magnet 210 and a secondary magnet 220 that are disposed in the same layer and spaced apart. That is, a magnetic gap is formed between the primary magnet 210 and the secondary magnet 220. Both the primary magnet 210 and the secondary magnet 220 are connected to the first housing 110. The first magnetic conductive sheet 310 is connected to the secondary magnet 220. The second magnetic conductive sheet 330 is connected to the primary magnet 210. In addition, as shown in FIG. 4, at least part of the coil 400 extends into the magnetic gap, facilitating better interaction with the primary magnet 210 and the secondary magnet 220 and thus ensuring the magnetic induction intensity.

It is to be noted that, as shown in FIG. 4, a gap exists between the coil 400 and the first magnetic conductive sheet 310 and between the coil 400 and the second magnetic conductive sheet 330, and a gap exists between the coil 400 and the primary magnet 210 and between the coil 400 and the secondary magnet 220, thereby reducing a risk that the first magnetic conductive sheet 310, the second magnetic conductive sheet 330, the primary magnet 210, and the secondary magnet 220 collide with the coil 400 when the vibration exciter collides in the direction perpendicular to the first direction X, thus ensuring the high reliability.

In some embodiments, with continued reference to FIG. 3, multiple secondary magnets 220 are spaced apart along the circumferential direction of the primary magnet 210, the first magnetic conductive sheet 310 is annular, and the secondary magnets 220 are all connected to the first magnetic conductive sheet 310. With the secondary magnets 220, the number of magnetic components of the vibration exciter can be increased, and the magnetic induction intensity can be better improved.

To better improve the impact resistance of the vibration exciter, as shown in FIG. 3 and FIG. 4, the vibration exciter also includes a buffer layer 500. The buffer layer 500 has an energy absorption and buffering function.

Illustratively, the buffer layer 500 is disposed between the magnetic conductive assembly 300 and the housing 100 to buffer the impact force transmitted by the housing 100 to the magnetic conductive assembly 300, thereby preventing the vibration exciter from directly colliding with the housing 100 when dropping, reducing the risk of damage to the magnetic conductive assembly 300, and preventing the housing 100 from having a pit due to the impact and thus affecting the appearance of the vibration exciter. The buffer layer 500 may be made of an elastic material. For example, the buffer layer 500 may include one or more layers. For example, the buffer layer 500 includes a buffer material layer and an anti-adhesion layer. The buffer material layer may be made of pressure-sensitive double-sided adhesive (PSA). The anti-adhesion layer may be made of thermoplastic polyester (PET). The buffer material layer functions as a buffer. The anti-adhesion layer is configured for anti-adhesion of the buffer layer 500.

In an embodiment, a buffer layer 500 is disposed between the second housing 130 of the housing 100 and at least one of the first magnetic conductive sheet 310 or the second magnetic conductive sheet 330 to improve the buffering and energy absorption effect of the first magnetic conductive sheet 310 and the second magnetic conductive sheet 330. It is to be understood that a buffer layer 500 may or may not be disposed between the second cantilever structure 320 and the second housing 130. This is not limited in this embodiment. When a buffer layer 500 is disposed between the second cantilever structure 320 and the second housing 130, the buffer layer 500 is located between the first annular portion 321 of the second cantilever structure 320 and the second housing 130 to prevent the buffer layer 500 from affecting the elastic deformation of the first connectors 322 and ensure the buffering performance of the second cantilever structure 320.

The position relationship between the buffer layer 500, the magnetic conductive assembly 300, and the housing 100 may include the following three cases:

In an embodiment, as shown in FIG. 4, the buffer layer 500 is connected to the inner wall of the housing 100 and spaced apart from the magnetic conductive assembly 300. In this manner, the buffer layer 500 can not only achieve the buffering effect to prevent the magnetic conductive assembly 300 from colliding with the housing 100, but can also provide a certain movement space for the movement of the magnetic conductive assembly 300 in the first direction X. In addition, the buffer layer 500 is not disposed on the magnetic conductive assembly 300 so that the weight of the magnetic conductive assembly 300 is not too large, and the low-frequency response of the vibration exciter is ensured.

In another embodiment, the buffer layer 500 is connected to the magnetic conductive assembly 300 and spaced apart from the housing 100.

In another embodiment, as shown in FIG. 7, the buffer layer 500 is elastic, and the buffer layer 500 is in contact with both the inner wall of the housing 100 and the magnetic conductive element 300. The elastic buffer layer 500 does not interfere with the movement of the magnetic conductive assembly 300 in the first direction X, thereby ensuring the generation and transmission of vibration.

When the vibration exciter of this embodiment is used, in an example in which the first housing 110 is connected to the device body of the electronic device, the coil 400 generates an alternating magnetic field after being energized. Under the action of the magnetic field, the magnetic circuit system 200 and the magnetic conductive assembly 300 vibrate relative to the coil 400 and drive the first housing 110 to vibrate. The first housing 110 drives the device body of the electronic device to vibrate, thereby achieving the vibration feedback.

In the vibration exciter of this embodiment, the second cantilever structure 320 is integrated with the first magnetic conductive sheet 310, the first cantilever structure 120 is integrated with the first housing 110, and the first housing 110 and the first cantilever structure 120 may be metal structures. Compared with a split structure, the overall structural strength is higher, making the structure more resistant to drop tests, tumble tests, and other strength tests. The integral cantilever structure reduces other components and simplifies the assembly process of the vibration exciter, thereby reducing the material cost, improving the product yield, and greatly reducing the price cost of the entire product. The inner side of the second housing 130 of this embodiment is attached to the buffer layer 500, greatly improving the safety of dropping impact. It is to be emphasized that this embodiment uses an integral double-layer cantilever structure to increase the rotation rigidity of the vibration exciter, thereby suppressing swinging of the vibration exciter, reducing the magnetic gap, and improving the reliability and vibration performance of the vibration exciter.

An embodiment provides an electronic device. The electronic device includes the preceding vibration exciter and a device body. The housing 100 of the vibration exciter is connected to the device body. Illustratively, the second housing 130 or the first housing 110 of the housing 100 is connected to the device body. The electronic device of this embodiment has relatively high drop resistance and thus has a longer service life.

Illustratively, the electronic device may be a smart device such as a mobile phone, a tablet computer, or a handheld multimedia entertainment device. This is not limited in this embodiment.

It is to be noted that the preceding are preferred embodiments of this disclosure and the technical principles used therein. It is to be understood by those skilled in the art that this disclosure is not limited to the embodiments described herein. For those skilled in the art, various apparent modifications, adaptations, and substitutions can be made without departing from the scope of this disclosure. Therefore, while this disclosure is described in detail in conjunction with the preceding embodiments, this disclosure is not limited to the preceding embodiments and may further include more other equivalent embodiments without departing from the concept of this disclosure. The scope of this disclosure is determined by the scope of the appended claims.

What is claimed is:

1. A vibration exciter, comprising:
a housing comprising a first housing, a second housing, and a first cantilever structure connected between the first housing and the second housing, wherein the first cantilever structure is elastically deformable;
a magnetic circuit system disposed in the housing and connected to the first housing;
a magnetic conductive assembly disposed in the housing, wherein the magnetic conductive assembly comprises a first magnetic conductive sheet and a second cantilever structure that are integrally formed, the first magnetic conductive sheet is connected to the magnetic circuit system, the second cantilever structure is elastically deformable, and the first magnetic conductive sheet is connected to the housing by the second cantilever structure; and
a coil disposed in the housing and connected to the second housing, wherein the magnetic circuit system is configured to vibrate relative to the coil.

2. The vibration exciter of claim 1, wherein the second cantilever structure comprises a first annular portion and a plurality of first connectors, the plurality of first connectors are spaced apart along a circumferential direction of the first magnetic conductive sheet, for each first connector of the plurality of first connectors, one end of the first connector is connected to the first magnetic conductive sheet, the other end of the first connector is connected to the first annular portion, the plurality of first connectors are elastically deformable, and the first annular portion is connected to the housing.

3. The vibration exciter of claim 1, wherein the second cantilever structure comprises a plurality of first connectors, the plurality of first connectors are spaced apart along a circumferential direction of the first magnetic conductive sheet, for each first connector of the plurality of first connectors, one end of the first connector is connected to the first magnetic conductive sheet, the other end of the first connector is connected to the housing, and the plurality of first connectors are elastically deformable.

4. The vibration exciter of claim 2, wherein each first connector of the plurality of first connectors comprises at least two first connecting portions connected end to end, and two connected first connecting portions among the at least two first connecting portions are arranged at an obtuse angle.

5. The vibration exciter of claim 3, wherein each first connector of the plurality of first connectors comprises at least two first connecting portions connected end to end, and two connected first connecting portions among the at least two first connecting portions are arranged at an obtuse angle.

6. The vibration exciter of claim 1, wherein the first housing and the first cantilever structure are an integral structure, and the second cantilever structure is connected to at least one of the first housing, the first cantilever structure, or the second housing.

7. The vibration exciter of claim 6, wherein the first cantilever structure comprises a second annular portion and a plurality of second connectors, the plurality of second connectors are spaced apart along a circumferential direction of the first housing, for each second connector of the plurality of second connectors, one end of the second connector is connected to the first housing, the other end of the second connector is connected to the second annular portion, the plurality of second connectors are elastically deformable, and the second annular portion is connected to the second housing.

8. The vibration exciter of claim 1, wherein the magnetic conductive assembly further comprises a second magnetic conductive sheet, the second magnetic conductive sheet and the first magnetic conductive sheet are disposed in a same layer and spaced apart, and the coil is arranged to pass through a space between the first magnetic conductive sheet and the second magnetic conductive sheet;
the magnetic circuit system comprises a primary magnet and a secondary magnet that are disposed in a same layer, the primary magnet and the secondary magnet are both connected to the first housing, a magnetic gap is formed between the primary magnet and the secondary magnet, and at least part of the coil extends into the magnetic gap; and
the first magnetic conductive sheet is connected to the secondary magnet, and the second magnetic conductive sheet is connected to the primary magnet.

9. The vibration exciter of claim 8, wherein a plurality of secondary magnets are spaced apart along a circumferential direction of the primary magnet, the first magnetic conductive sheet is annular, and the plurality of secondary magnets are all connected to the first magnetic conductive sheet.

10. The vibration exciter of claim 1, further comprising a buffer layer disposed between the magnetic conductive assembly and the housing.

11. An electronic device, comprising a vibration exciter and a device body, wherein the vibration exciter comprises a housing, a magnetic circuit system disposed in the housing, a magnetic conductive assembly disposed in the housing, and a coil disposed in the housing, wherein the housing comprises a first housing, a second housing, and a first cantilever structure connected between the first housing and the second housing, and the first cantilever structure is elastically deformable; the magnetic circuit system is connected to the first housing; the magnetic conductive assembly comprises a first magnetic conductive sheet and a second cantilever structure that are integrally formed, the first magnetic conductive sheet is connected to the magnetic circuit system, the second cantilever structure is elastically deformable, and the first magnetic conductive sheet is connected to the housing by the second cantilever structure; and the coil is connected to the second housing, and the magnetic circuit system is configured to vibrate relative to the coil;
wherein the housing of the vibration exciter is connected to the device body.

12. The electronic device of claim 11, wherein the second cantilever structure comprises a first annular portion and a plurality of first connectors, the plurality of first connectors are spaced apart along a circumferential direction of the first magnetic conductive sheet, for each first connector of the plurality of first connectors, one end of the first connector is connected to the first magnetic conductive sheet, the other end of the first connector is connected to the first annular portion, the plurality of first connectors are elastically deformable, and the first annular portion is connected to the housing.

13. The electronic device of claim 11, wherein the second cantilever structure comprises a plurality of first connectors, the plurality of first connectors are spaced apart along a circumferential direction of the first magnetic conductive sheet, for each first connector of the plurality of first connectors, one end of the first connector is connected to the first magnetic conductive sheet, the other end of the first connector is connected to the housing, and the plurality of first connectors are elastically deformable.

14. The electronic device of claim 12, wherein each first connector of the plurality of first connectors comprises at least two first connecting portions connected end to end, and two connected first connecting portions among the at least two first connecting portions are arranged at an obtuse angle.

15. The electronic device of claim 13, wherein each first connector of the plurality of first connectors comprises at least two first connecting portions connected end to end, and two connected first connecting portions among the at least two first connecting portions are arranged at an obtuse angle.

16. The electronic device of claim 11, wherein the first housing and the first cantilever structure are an integral structure, and the second cantilever structure is connected to at least one of the second housing, the first cantilever structure, or the second housing.

17. The electronic device of claim 16, wherein the first cantilever structure comprises a second annular portion and a plurality of second connectors, the plurality of second connectors are spaced apart along a circumferential direction of the first housing, for each second connector of the plurality of second connectors, one end of the second connector is connected to the first housing, the other end of the second connector is connected to the second annular portion, the plurality of second connectors are elastically deformable, and the second annular portion is connected to the second housing.

18. The electronic device of claim 11, wherein the magnetic conductive assembly further comprises a second magnetic conductive sheet, the second magnetic conductive sheet and the first magnetic conductive sheet are disposed in a same layer and spaced apart, and the coil is arranged to pass through a space between the first magnetic conductive sheet and the second magnetic conductive sheet;
the magnetic circuit system comprises a primary magnet and a secondary magnet that are disposed in a same layer, the primary magnet and the secondary magnet are both connected to the first housing, a magnetic gap is formed between the primary magnet and the secondary magnet, and at least part of the coil extends into the magnetic gap; and
the first magnetic conductive sheet is connected to the secondary magnet, and the second magnetic conductive sheet is connected to the primary magnet.

19. The electronic device of claim 18, wherein a plurality of secondary magnets are spaced apart along a circumferential direction of the primary magnet, the first magnetic conductive sheet is annular, and the plurality of secondary magnets are all connected to the first magnetic conductive sheet.

20. The electronic device of claim 11, wherein the vibration exciter further comprises a buffer layer disposed between the magnetic conductive assembly and the housing.
